(19) United States
(12) Patent Application Publication
(10) Pub. No.: US 2010/0125526 A1
(43) Pub. Date: May 20, 2010

(54) Three Party Services Transaction System

(75) Inventors: Jay Hurley, Watsonville, CA (US); Dave Brown, Carmel Valley, CA (US); Lisa Alderson, Monterey, CA (US); Tom Rolander, Pacific Grove, CA (US); Vikram Subramaniam, San Jose, CA (US)

Correspondence Address: Soquel Group, LLC, P.O. Box 691, Soquel, CA, 95073, US

(73) Assignee: CROSSLOOP INC., Monterey, CA (US)

(21) Appl. No.: 12/367,494

(22) Filed: Feb. 6, 2009

Related U.S. Application Data
(60) Provisional application No. 61/114,888, filed on Nov. 14, 2008.

(51) Int. Cl. G06Q 30/00; G06Q 10/00; G06Q 20/00

(52) U.S. Cl. 705/80; 705/34

(57) ABSTRACT

A method of entering into and performing a service agreement, comprising maintaining a provider account database comprising records for service providers; providing a website that enables a customer to interactively select a service provider from the provider account database; enabling said service provider to provide an electronic estimate form that includes a description of work to be perform and an estimated price; enabling said customer to accept or reject said price estimate; enabling said service provider to submit a bill for work performed following acceptance of said price estimate; enabling said customer and said service provider to exchange messages via interactive chat wherein said chat is in reference to exchanged forms and bill data; and electronically obtaining money from the customer and transferring the money to an account from which the service provider is paid.

### PRIORITY REFERENCE TO RELATED APPLICATIONS

This application claims benefit of U.S. Provisional Application No. 61/114,888, entitled THREE PARTY SERVICES TRANSACTION SYSTEM, filed on Nov. 14, 2008 by inventor Vikram Subramaniam et al.

### FIELD OF THE INVENTION

The present invention relates to electronic online commerce (e-commerce). In particular it deals with systems and methods that enable e-commerce transactions to be effectively used for the provision of services.

### BACKGROUND OF THE INVENTION

E-commerce technology enables consumers to purchase items of merchandise on-line. Pioneers of e-commerce include Amazon.com, Inc. of Seattle, Wash. and eBay Inc. of San Jose, Calif. Generally, e-commerce websites such as Amazon.com have focused on enabling companies to sell merchandise on-lines from websites that act as virtual stores. eBay added the ability for individuals and companies (“sellers”) to auction both used and new items of merchandise to the highest bidder. Because of the complexities and risks associated witch auctioning items of merchandise, the eBay system includes a means for buyers and sellers to exchange information, separate from the main bidding mechanism.

More recently, online marketplaces for online buying and selling of services such as programming, web design, accounting, legal, writing and translation have emerged. One pioneer of online service marketplaces is Elance, Inc. of Mountain View, Calif. Elance allows a customer to describe a project, offer the projects to service providers, registered with the Elance service, for bid, accept bids from such service providers, and select a bid.

Thus, services marketplaces now enable providers of services and individuals as well as companies seeking services (henceforth referred to simply as customers) to discover each other and enter into services agreements. However, the basic steps in a service agreement such as providing and revising estimates, billing and dispute resolution have not been integrated into such services marketplaces. Further, traditional e-commerce transaction systems are not well suited to enable such business transactions to be automated. For example, there are often textual agreements relating to quality, schedule and manner of work that are not readily captured in a traditional e-commerce system.

There is thus a need for an online services transaction system that enables customers and service providers to enter into services transactions and which manages all steps of the transaction up to and including payment.

### SUMMARY OF THE DESCRIPTION

The present invention concerns a services transaction system (henceforth referred to as “STS”) that enables customers and service providers (henceforth also referred to simply as “providers”) to enter into services agreements and which automates and guides all steps of the transaction including submitting an estimate, revising the estimate, submitting a final bill, and accepting electronic payment. The STS extends the concept of an electronic transaction system by providing a transparent estimate and billing process that enables both customers and providers to share the same information at each step.

The present invention enables three parties to participate in the service agreement, the three parties being a customer, a service provider and a STS. The STS acts as an enabler, or broker, by providing a secure, safe online system that enables a customer and a service provider to enter into a services agreement and to perform an e-commerce transaction. In this regard, the agreement is between the customer and the provider; STS itself is not a party to the agreement.

Further, by capturing historical information, the STS gives providers and customers information that enables them to balance the risk and reward of entering into service agreements with each other. For example, a provider can review the payment history and ratings associated with a prospective customer before entering into a service agreement. Conversely, a customer can review historical information such as ratings associated with a prospective service provider before entering into a service agreement.

The STS enables customers to pay using conventional electronic payment methods including credit cards and PayPal. It uses the credit authorization process to ensure that a prospective customer is capable of paying up to the estimated amount. Further, it uses the authorization-settlement process to provide a brief escrow period that enables a customer to dispute a bill prior to the service provider being paid for the service.

The present invention integrates interactive chat with forms-based transaction processing to provide a comprehensive system for both reaching and recording an agreement between customer and provider. The STS system itself interacts using both text messages and forms processing. The chat messages are considered part of the transaction and are stored along with other transaction data in a historical record that can be used by STS administrators to resolve disputes.

In one embodiment, the STS enables providers to offer computer technical support services to customers. For example, a customer may want assistance in using a spreadsheet or other software package; or a customer may want a provider to eliminate a computer virus that is causing their personal computer to malfunction. In this embodiment, the customer and the provider may use a screen sharing system that enables the provider to remotely control the customer's computer and thus directly perform the service.

### BRIEF DESCRIPTION OF THE DRAWINGS

The present invention will be more fully understood and appreciated from the following detailed description, taken in conjunction with the drawings in which:

FIG. 1 is an illustration of an exemplary operating environment in which the present invention may operate, in accordance with an embodiment of the present invention;

FIG. 2 is a high-level block diagram of a services transaction system, in accordance with an embodiment of the present invention;

FIG. 3 is a flow diagram that illustrates a simplified overall method performed by a services transaction system, in accordance with an embodiment of the present invention;

FIGS. 4A and 4B provide a flow diagram for a preferred embodiment of the overall method illustrated in FIG. 3, in accordance with an embodiment of the present invention;

FIG. 5A is an example user interface used by a customer to view information about and chat with a provider in a services transaction system, in accordance with an embodiment of the present invention;

FIG. 5B is an example user interface used by a provider to make an estimate to perform a specified service for a customer, in accordance with an embodiment of the present invention;

FIG. 5C is an example user interface used by a customer to view an estimate made by a provider and to accept or decline the estimate, in accordance with an embodiment of the present invention;

FIG. 5D is an example user interface used by a provider to revise an estimate that he/she previously submitted to a customer, in accordance with an embodiment of the present invention;

FIG. 5E is an example user interface used by a provider to specify and submit a final bill to a customer for services that he/she has completed, in accordance with an embodiment of the present invention;

FIG. 5F is an example user interface used by a services transaction system to revise a final bill submitted by a provider to reflect the last estimate made by the provider, in accordance with an embodiment of the present invention;

FIG. 5G is an example user interface used by a provider to provide feedback following a transaction, in accordance with an embodiment of the present invention;

FIG. 5H is an example user interface used by a customer to provide feedback following a transaction, in accordance with an embodiment of the present invention;

FIG. 6 is an example software architecture for a services transaction system server computer, in accord with an embodiment of the present invention; and

FIG. 7 is a block diagram of an example server infrastructure that identifies software components included in a services transaction system server computer, in accord with an embodiment of the present invention.

### DETAILED DESCRIPTION

The invention is described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the invention may be embodied as methods, processes, systems, business methods, or devices. Accordingly, the present invention may take the form of an entirely hardware embodiment or an embodiment combining software and hardware aspects. The following detailed description is, therefore, not to be taken in a limiting sense.

The present invention enables a customer to enter into a service agreement with a service provider and perform an e-commerce transaction that enables selection of a provider by a customer, estimation of the cost or providing a service by a provider, billing by a provider, electronic payment, and evaluation by both a provider and a customer.

### Exemplary Operating Environment

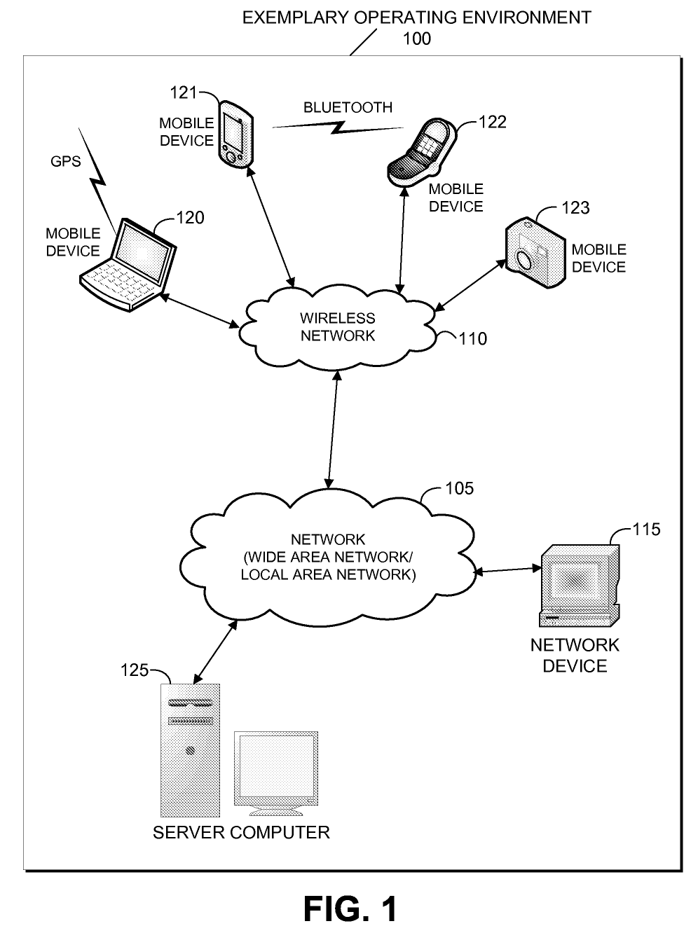

Now reference is made to FIG. 1, which is an illustration of an exemplary operating environment in which the present invention may operate, in accordance with an embodiment of the present invention. Not all the components may be required to practice the invention, and variations in the arrangement and type of the components may be made without departing from the spirit or scope of the invention. As depicted in FIG. 1, system 100 includes a network 105 that includes one or more interconnected local area networks (“LANs”) and wide area networks (“WANs”), a wireless network 110, a network device 115, four mobile devices 120-123, and a server computer 125. Network device 115 and mobile devices 120-123 are client devices that communicate with server computer 125. Client devices may also communicate among themselves using peer-to-peer networking or using a near field communications system.

Network 105 connects server computer 125 to other computing devices, including, to network device 115, and through wireless network 110 to mobile devices 120-123. Also, network 105 can include the Internet in addition to local area networks (LANs), wide area networks (WANs), direct connections, such as through a universal serial bus (USB) port, other forms of computer-readable media, or any combination thereof. In essence, network 105 includes any communication method by which information may travel between server computer 125, network device 115, and mobile devices 120-123 and with other computing devices as well.

Wireless network 110 is configured in part to couple mobile devices 120-123 with network 105. Wireless network 110 may include any of a variety of wireless sub-networks to connect mobile devices 120-123.

Network device 115 may include virtually any computing device capable of communicating over a network to send and receive information. In this context network device 115 refers to devices that typically connect using a wired or wireless communications medium such as desktop personal computers, laptop personal computers, multiprocessor systems, microprocessor-based or programmable consumer electronics, network PCs, and network appliances.

Generally, mobile devices 120-123 may include any portable computing device capable of receiving and sending a message over a network such as network 105 and wireless network 110. Mobile devices 120-123 include cellular telephones, smart phones, personal digital assistants (PDAs), handheld computers, digital cameras, laptop computers, wearable computers, tablet computers, media players, and video game consoles. Mobile devices 120-123 range widely in terms of capabilities and features. For example, a mobile telephone may have a numeric keypad and a few lines of monochrome LCD display on which only text may be displayed. In another example, a web-enabled mobile device may have an alphanumeric keypad and a LCD display capable of displaying full color presentations, digital photos, word processing documents, email messages and web pages.

Mobile devices 120-123 typically include a web browser application that is configured to receive and to send web pages, web-based messages, and other web-based communications. The web browser application may be configured to display and browse web pages and receive and display a variety of media including photos, music, graphics, and text. Mobile devices 120-123 are typically capable of running mobile applications that send and receive content across wireless network 110. Mobile applications may be capable of receiving, sending, creating, and editing text, photos, audio and music, graphics and other digital media files. The mobile application may further provide information that identifies itself, including a type, capability, and name. Mobile devices 120-123 may uniquely identify themselves through any of a variety of mechanisms, including a phone number, Mobile Identification Number (MIN), an electronic serial number (ESN), or other mobile device identifier.

Some mobile devices 120-123 are capable of communicating with external devices in close proximity using near field communications technologies such as infrared, and Bluetooth™.

Further, some mobile devices 120-123 include a geopositioning mechanism such as a GPS transceiver that can determine the physical coordinates of mobile devices 120-123 relative to the surface of the Earth. It is understood that the GPS transceiver may determine a physical location within millimeters in some cases and may be less precise, such as within 5-10 meters or even greater distances, in other cases.

Mobile devices 120-123 and network device 115 may be configured to include an application that enables a user to log into a customer account that may be managed by another computing device, such as server computer 125. Such customer account may enable the user to, for example, search for, view and retrieve content, and select content or merchandise for purchase. However, participation in these activities may not require the user to log into a customer account.

Server computer 125 may include any computing device capable of connecting to network 105. Further, server computer 125 enables one or more server applications to communicate with clients and/or other server applications operating on other computing devices. Server computer 125 applications include but are not limited to database management systems, Web server, digital asset management (DAM), e-commerce, and social networking.

Furthermore, although FIG. 1 illustrates server computer 125 as a single computing device, the invention is not so limited. For example, one or more functions or applications of server computer 125 may be distributed across one or more other network devices without departing from the spirit and scope of the invention.

### Services Transaction System

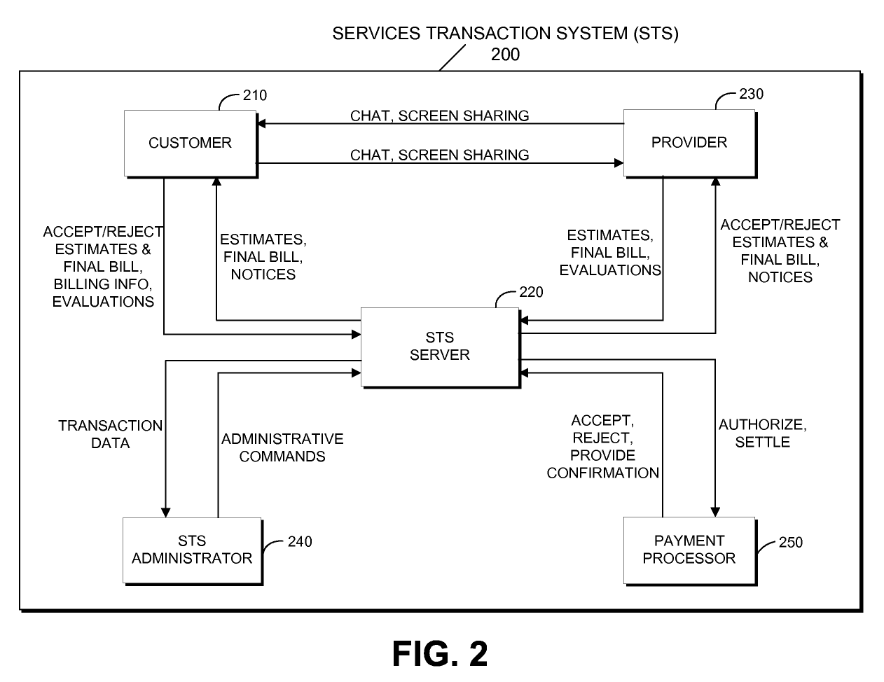

Reference is now made to FIG. 2, which is a high-level block diagram of a services transaction system, in accordance with an embodiment of the present invention.

A transaction performed by a services transaction system (henceforth referred to as “STS” for purposes of brevity) involves three parties:
1. a customer 210 is a person that uses a network device such as network device 115 or a mobile device such as mobile device 120, 121, 122 or 123 to access and derive services from a website provided by a STS server 220;
2. a provider 230 is a person that uses a network device or a mobile device to access the website provided by STS server 220 to interact with and perform a services transaction with customer 210. It may be appreciated that the services provided by provider 230 may require the use of a computer as, for example, in the case of removing a virus from the personal computer of customer 210. Alternatively, the service may not involve a computer such as in the case that the service to be provided is house painting. All that is implied and necessary is that provider 230 advertise his/her services using the STS website and use STS 200 to perform the services transaction; it is not necessary in the present invention that provider 230 use STS 200 or even a computer to perform the actual service contracted for.
3. a STS server 220 is a server computer such as server computer 125 that provides a website that enables customers 210 and providers 230 to perform service transactions.

In addition, STS server 220 may enable a STS administrator 240 to perform administrative functions. Functions that may be performed by an STS administrator 240 may include dispute resolution, reviewing transactions, defining reports and user management. Generally, an administrator 240 issues administrative commands in response to transaction and customer data provided by STS server 220.

Further customer 210 and provider 230 may interactively chat, i.e. exchange textual messages, images, sound and other types of media. It may be appreciated that whereas FIG. 2 depicts chat as being peer-to-peer, in fact the messages may flow through STS server 220 or through a third party chat service. In addition, STS 200 may provide a screen sharing capability that enables provider 230 to remotely control the network computer or mobile device used by customer 210. Again, it may be appreciated that whereas FIG. 2 depicts screen sharing as being peer-to-peer, in fact the screen sharing data may flow through STS server 220 or through a 3^{rd} party screen sharing service.

STS server 220 includes a payment processor 250 which is an electronic payment service that interacts with a banking network to authorize and settle electronic payments. Payment processor 250 may be inter alia a service such as PayPal, a standard credit card processor provided by a third party that itself interacts across a credit card network such as VISA, or an internal component of STS server 220 that interacts directly with credit card networks.

### Simplified Overall Method

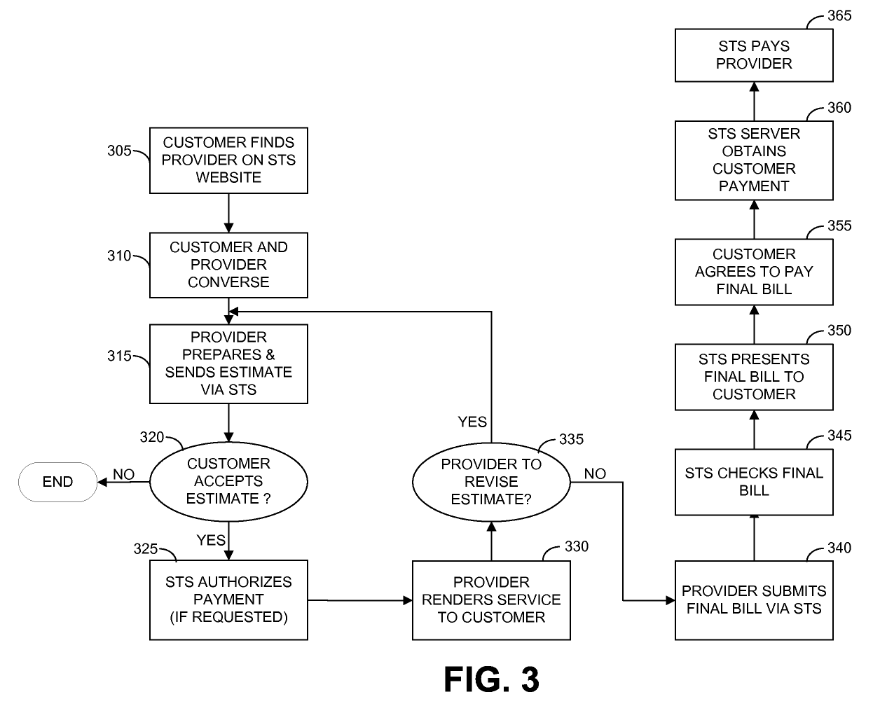

Reference is now made to FIG. 3, which is a flow diagram that illustrates a simplified overall method peformed by a services transaction system (STS), in accordance with an embodiment of the present invention. In seeking an individual or company to provide a service, customer 210 uses a standard Web browser such as Firefox, by Mozilla or Internet Explorer by the Microsoft Corporation, to find the website provided by STS server 220 (henceforth referred to as the “STS website”). At step 305 customer 210 uses the search and browse tools provided by the STS website to find provider 230. At step 310 customer 210 and provider 230 converse, typically discussing inter alia the service to be provided, the background of provider 230, as well as schedule and price issues. The conversation between customer 210 and customer 230 can use any available means including interactive chat provided by STS website and telephone. At step 315, provider 230 prepares an estimate that specifies the services to be performed and the price to be charged for the proposed service, using an interface provided by STS server 220 and sends the estimate via the STS server 220 to customer 210. STS server 220 stores this price estimate in a variable named “Last Estimate” which always tracks the last estimate from provider 210. At step 320, customer 210 uses an interface provided by STS server 220 to accept the estimate. If customer 210 does not accept the estimate, i.e. rejects the estimate, then the method terminates. In one embodiment, customer 210 and provider 230 may converse further and provider 230 may subsequently submit a new estimate.

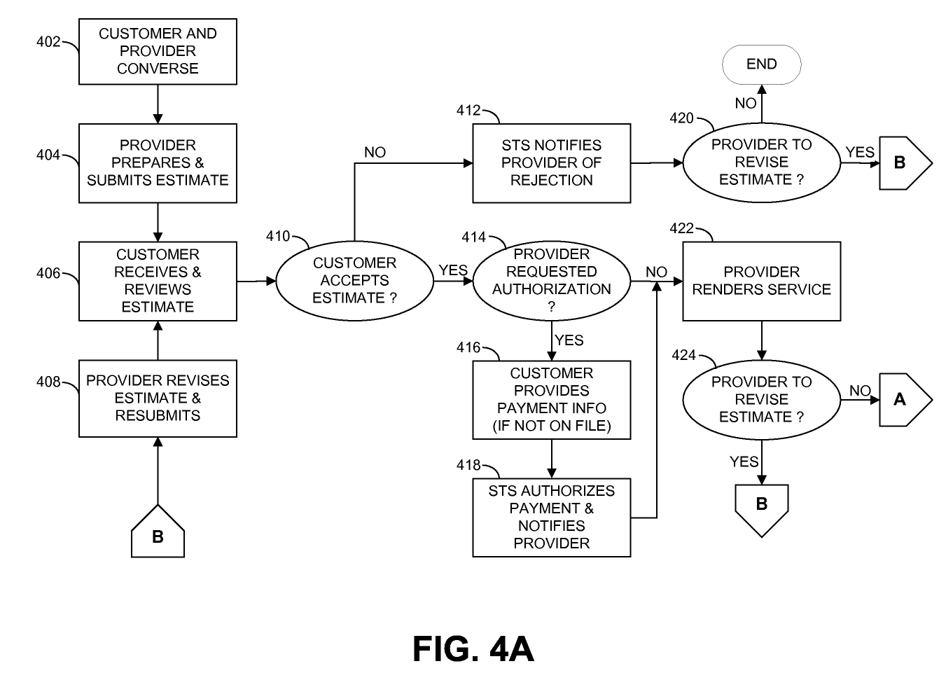

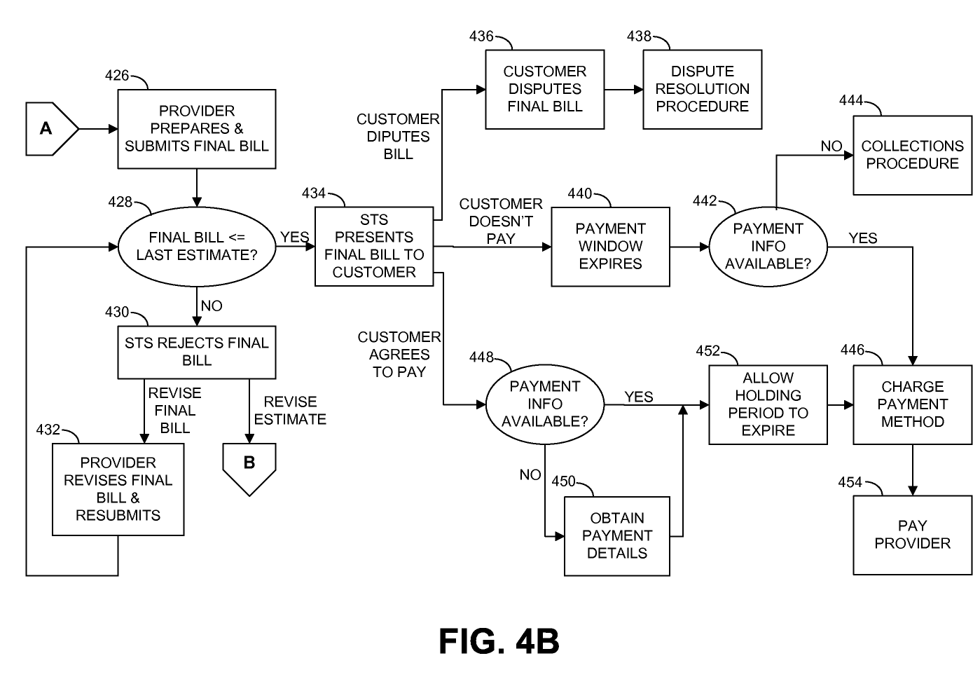

Once customer 210 accepts an estimate, then at step 330 provider 230 renders the service agreed to in the estimate. Either while rendering the service or at the conclusion of rendering the service, provider 230, at step 335 may decide to revise the estimate in which case control returns to step 315. If provider 230 does not revise the estimate then after rendering the service, at step 340, he/she submits a final bill to provider 230 using an interface provided by STS server 220. At step 345 STS server 220 checks the final bill. A preferred embodiment of the consistency checking and subsequent actions performed by STS server 220 is described with reference to FIG. 4B.

Once STS server 220 checks and approves the final bill, then at step 350 STS server 220 presents the final bill to customer 230 for payment. At step 355 customer 210 agrees to pay the final bill. Other cases, including the case where the customer does not respond to the final bill are described with reference to FIG. 4B. Then, at step 360 STS server uses the method of payment details provided by customer 210 to obtain payment for the final bill. Typically, STS server causes the payment to be deposited directly into a customer payments bank account managed by STS 200. Finally, at step 365 STS 200 pays provider 230.

### PREFERRED EMBODIMENT

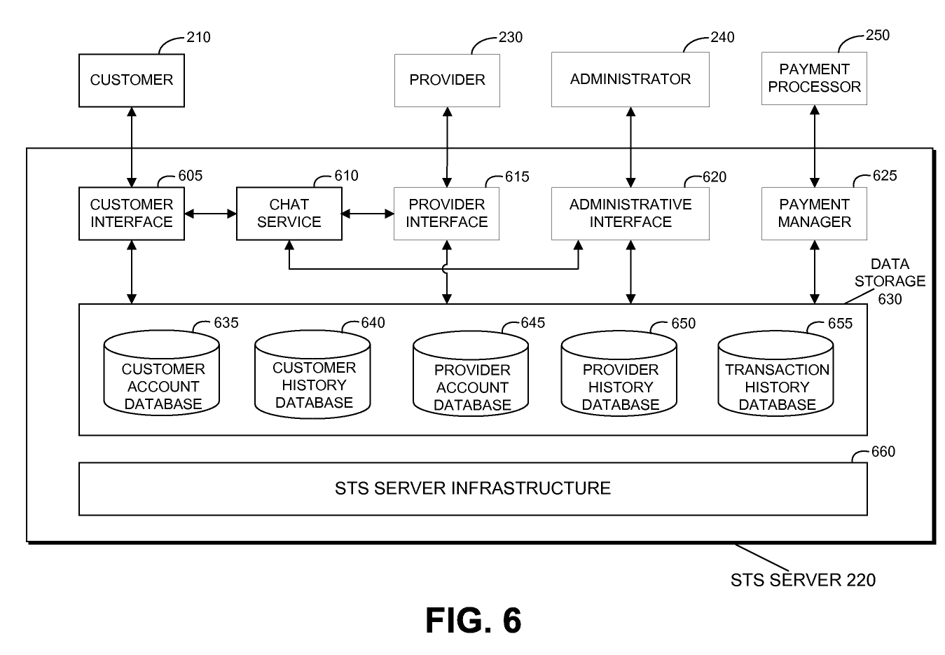

Now reference is made to FIGS. 4A and 4B, which provide a flow diagram for a preferred embodiment of the overall method illustrated in FIG. 3, in accordance with an embodiment of the present invention. At step 402 of FIG. 4A customer 210 and provider 230 converse, typically using an interactive chat service provided by STS server 220. The advantage of the chat service over other methods, such as telephone, that may be used for such conversation is that STS server 220 stores the entire chat history along with other details of the transaction in a transaction history database, described later with respect to FIG. 6. At step 404 provider 230 prepares and submits an estimate, also commonly referred to as a bid, to customer 210. The estimate is made using an interface provided by STS server 220. STS server stores the amount of the estimate in a variable named “Last Estimate.” At step 406 customer 210 receives and reviews the estimate. At step 410 customer 210 decides if they want to accept or reject the estimate. If customer 210 rejects the estimate, then at step 412 STS server notifies provider 230 of the rejection. Then, at step 420 provider 230 determines if he/she wishes to revise the estimate in an attempt to reach an agreement with customer 210. If provider 230 wishes to revise the estimate then control passes to step 408 where provider 210 revises the estimate and resubmits it. If provider 230 does not wish to revise the estimate then the method ends.

If at step 410 customer 210 accepts the estimate then at step 414 a determination is made whether provider 230 has requested authorization of payment from customer 210. At step 416, if provider 230 requests authorization then STS server 220 presents a method of payment form to customer 210 and customer 210 provides his/her method of payment information using said form. Then, at step 418 STS server 220 requests authorization of payment from payment processor 250 for the amount of the last estimate.

Once an estimate has been accepted and authorization of payment, if requested, is successfully performed, the procedure resumes at step 422 where provider 230 renders the service that has been discussed and agreed to in the estimate. At any time, either while performing the service of after completing the service, provider 230 may revise his/her estimate. If at step 424 provider 230 decides to revise his/her estimate then control passes to step 408. If provider 230 does not want to revise his/her estimate then control resumes at step 426 of FIG. 4B.

At step 426 of FIG. 4B, provider 230 prepares and submits a final bill using an interface provided by STS server 220. At step 428 STS server 220 determines if the amount charged in the final bill is less than or equal to the amount of Last Estimate, the value stored from the last estimate made by provider 230. If the amount is greater, then at step 430 STS server 220 rejects the final bill; in this case STS server displays the final bill to provider 230 with a message explaining the error. At this point provider 230 may choose to revise the final bill and resubmit it (step 432) or provider 230 may choose to revise the estimate in which case control passes to step 408 of FIG. 4A. In this embodiment, STS sever does not allow provider 230 to submit to customer 210 a final bill with an amount greater than Last Estimate; thus provider 230 must either revise the final bill to be less than or equal to Last Estimate or provider 230 must submit a revised estimate to customer 210 and obtain their agreement before submitting a final bill. In another embodiment the test as to whether the final bill exceeds Last Estimate, at step 428, is not performed. In this embodiment, provider 230 is allowed to submit a final bill in any amount.

At step 434, after a final bill has been submitted by provider 230 and approved by STS server 220, STS server 220 presents the final bill to customer 210 for review and payment. STS server 220 is capable of responding to the following cases: (1) customer 210 disputes the bill, (2) customer 210 doesn't pay the final bill, and (3) customer 210 agrees to pay the final bill and performs a sequence of steps leading to payment.

At step 436, customer 210 chooses to dispute the final bill. This leads, at step 438, the two parties, customer 210 and provider 230, to enter into a dispute resolution procedure. In one embodiment, customer 210 may issue a specific command that informs provider 230 that he/she does not agree to pay and that also notifies STS administrator 240 of the dispute. Then, STS administrator 240 settles the dispute online using a series of electronic dispute resolution forms, or offline, i.e. outside a STS procedure using inter alia emails, chat and telephone calls. Then STS administrator 240 sends a message detailing the resolution that displays in the browser window of both customer 210 and provider 230.

If customer 210 doesn't pay the final bill, then STS server 220 periodically determines at step 440 whether a payment window, i.e. a pre-established time interval, has expired. Once the payment window expires, then at step 442, STS server 220 determines if payment information is available for customer 210. If a payment method is available then at step 446 customer 210 is charged the amount of the final bill. Typically, STS server 220 would also send a message to customer 210 informing them that the payment window has expired and that his/her payment method is being used to pay the final bill. If no payment method is available then, at step 444, the final bill is sent to collections. Typically, the final bill is sent again to customer 210 as an electronic invoice via email, or even regular postal mail. If the final bill is still not paid by customer 210 after a period of time then the bill is provided to an external collections agency. It may be appreciated by one skilled in the art that procedures for collecting an overdue bill are well understood in the retail and services industries and can be handled in a variety of ways. The actual collections procedure is outside the scope of the present invention.

If customer 210 agrees to pay the final bill then at step 448 STS server determines if payment information is available for customer 210. If not, then at step 450 STS server obtains payment information from customer 210.

At step 452 STS server 220 allows an agreed to holding period (also referred to as escrow period) to expire prior to obtaining payment. In one embodiment the escrow period is two days and during these two days customer 210 has the right to determine that the service provided by provider 230 was unsatisfactory and to refuse payment. At step 446 STS server uses the method of payment details provided by customer 210 to obtain payment for the final bill. Typically, STS server 220 causes the payment to be deposited directly into a customer payments bank account managed by STS 200.

Finally, at step 454 STS server causes payment to be made to provider 230. Typically payment is made periodically, for example monthly or biweekly, and all payments collected during this time period for services rendered by provider 230 are aggregated and paid at one time. Typically, payment is made by a direct deposit or wire transfer from the customer payments bank account managed by STS 200 to a bank account designated by provider 230.

### Exemplary User Interfaces

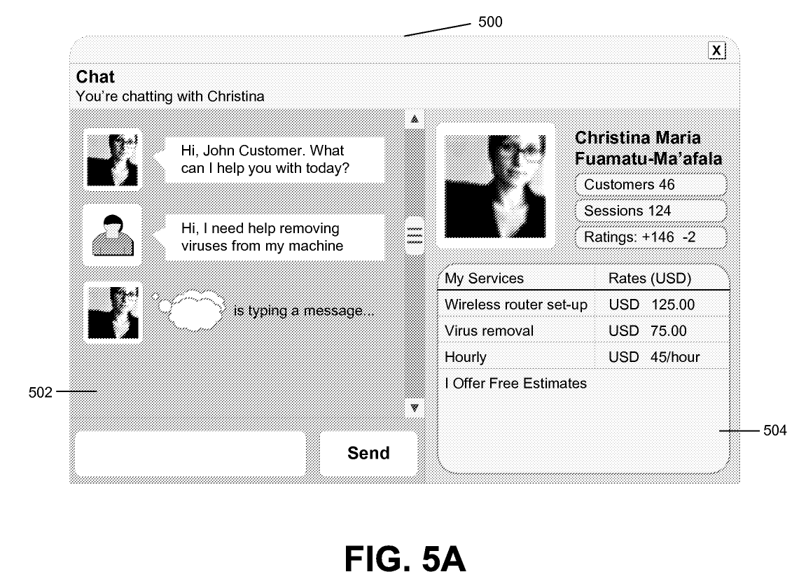

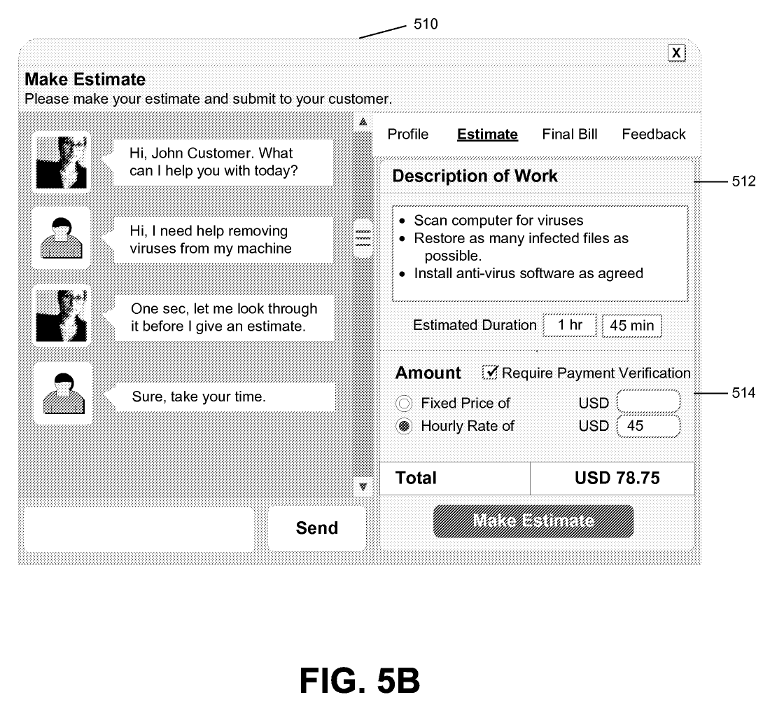

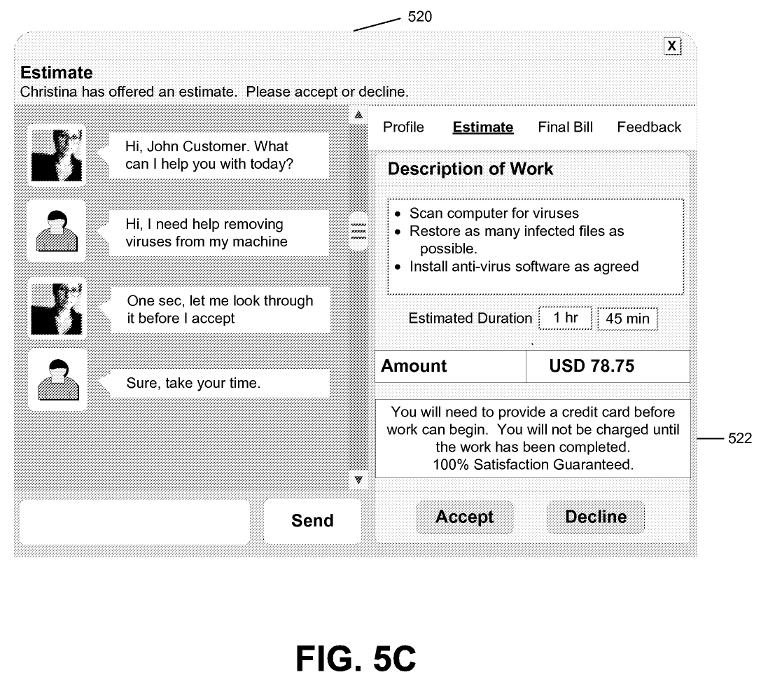

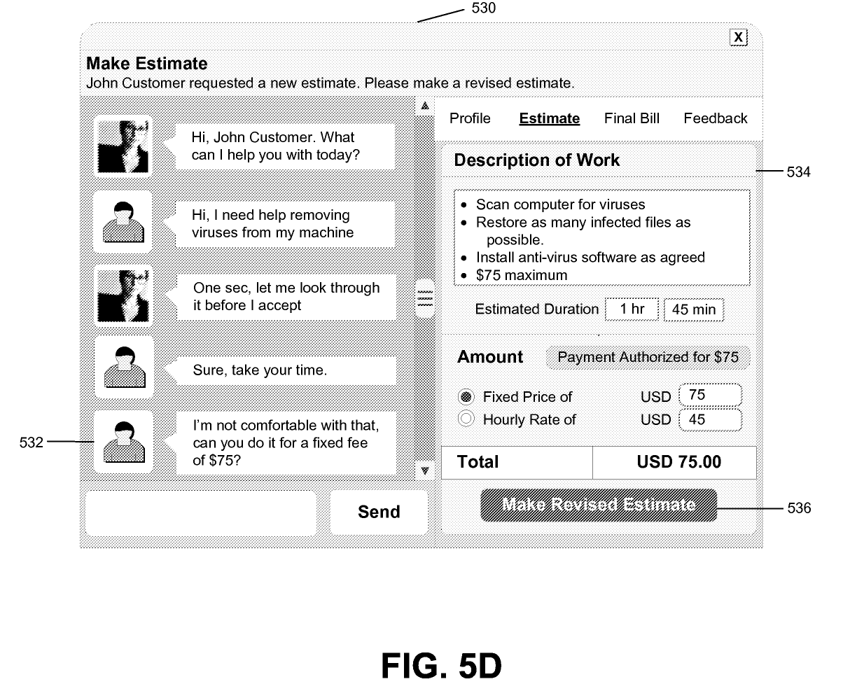

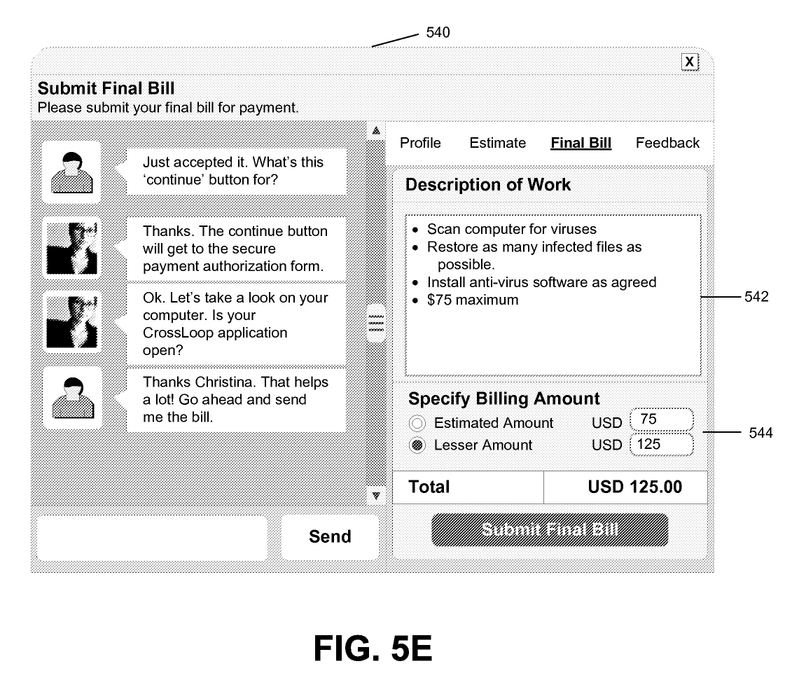

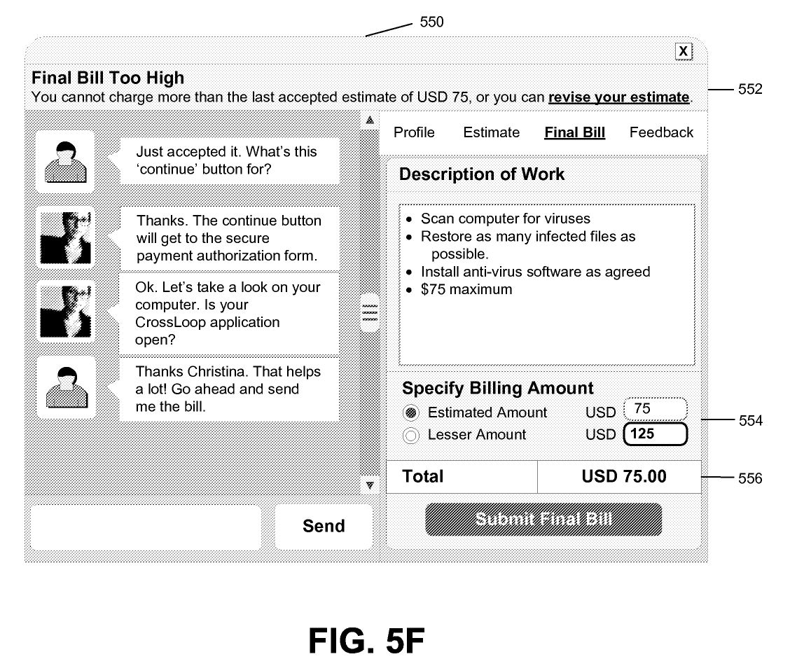

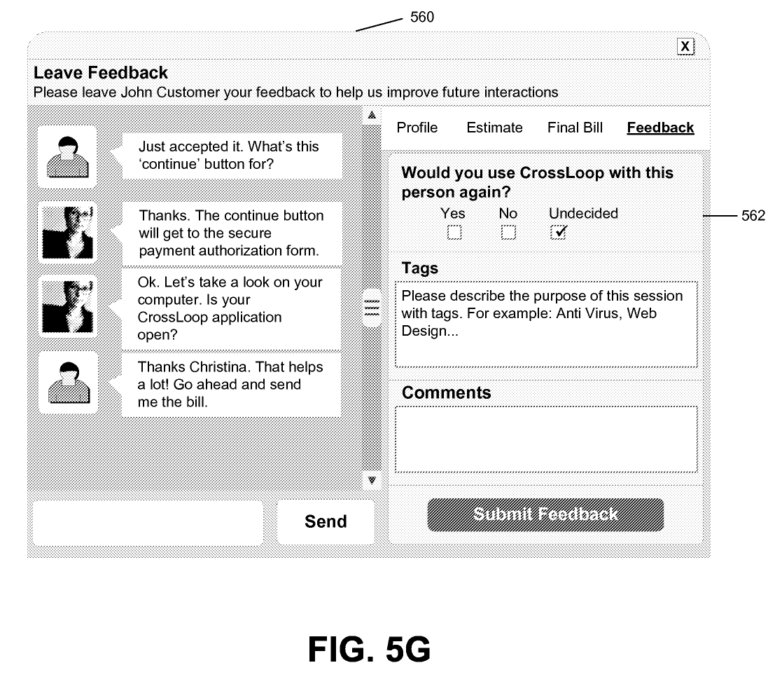

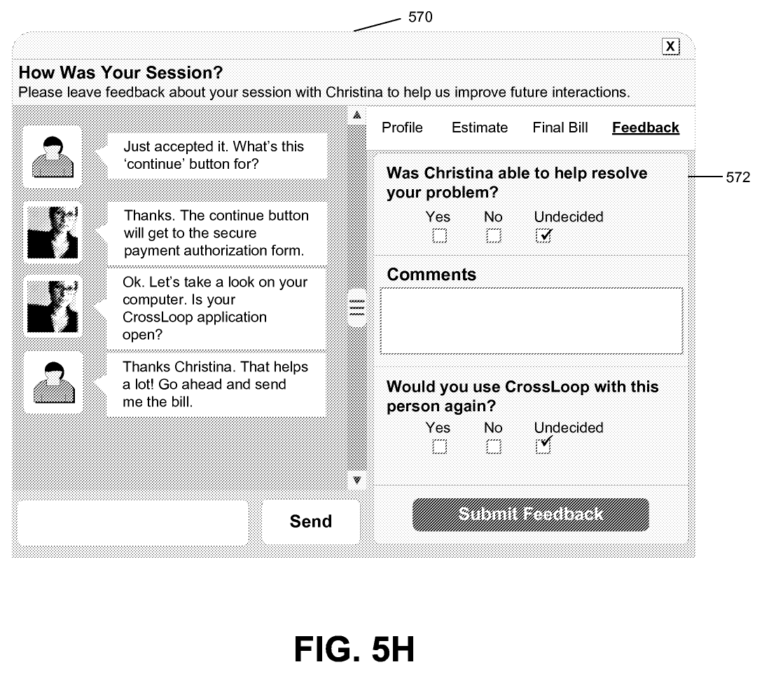

Now reference is made to FIG. 5A, which is an example user interface used by a customer to view information about and chat with a provider in a services transaction system, in accordance with an embodiment of the present invention. User interface 500 combines interactive chat with forms-based transaction processing. The main window is divided into a left pane 502 and a right pane 504. Left pane 502 displays a sequence of chat messages between customer 210 and provider 230. STS server 220 may also post text messages in left pane 502. Right pane 504 presents structured, forms-based, information. The forms are managed and presented by STS server 220. Typically, forms display messages from STS server 220 combined with entry fields into which customer 210 or provider 230 enters information. In the example depicted in FIG. 5A, right pane 504 presents information about provider 230 for review by customer 210.

Now reference is made to FIG. 5B, which is an example user interface used by a provider to make an estimate to perform a specified service for a customer, in accordance with an embodiment of the present invention. The right pane 512 of window 510 is a form that enables provider 230 to specify a description of the work to be performed, an estimated duration, a pricing approach, and an estimated price. A pricing control 514 enables provider 230 to specify that the estimate is either a fixed price or based on an hourly rate. In the example, provider 230 estimates that the work will take 1.75 hours; thus at an hourly rate of $45 the estimate computes to $78.75. While only two alternative pricing methods are illustrated in this example, fixed price and an hourly rate, the present invention allows a broad range of pricing methods. For example, a monthly subscription rate might be applied for a service such as regular performance tuning of a personal computer or computer server. Pricing control 514 enables provider 230 to specify whether or not to require payment verification. If payment verification is required then customer 210 must be pre-authorized up to the amount of the estimate before provider 230 commences providing the agreed-to service.

Now reference is made to FIG. 5C, which is an example user interface used by a customer to view an estimate made by a provider and to accept or decline the estimate, in accordance with an embodiment of the present invention. In this example, provider 230 has specified that the estimate must be preauthorized prior to commencing work. Consequently, a message 522 displayed in the right pane informs customer 210 that he/she must provide his/her credit card information and that the amount of the estimate will be authorized.

Now reference is made to FIG. 5D, which is an example user interface used by a provider to revise an estimate that he/she previously submitted to a customer, in accordance with an embodiment of the present invention. In the example, customer 210 previously indicated in a chat message 532 that he/she would prefer a fixed price. Provider 230 responds by completing a new estimate form 534 and then clicks on a Make Revised Estimate control 536 to submit the estimate to STS server 220. STS server 220 in turn presents the estimate to customer 210 for review/approval.

Now reference is made to FIG. 5E, which is an example user interface used by a provider to specify and submit a final bill to a customer for services that he/she has completed, in accordance with an embodiment of the present invention. In this example, a message 542 in the right pane of example user interface 540 indicates that a maximum price of $75 will be charged, as previously agreed to between customer 210 and provider 230. However, in a Specify Billing Amount control 544 provider 230 enters an amount of $125 for the final bill which exceeds the estimate amount of $75.

Now reference is made to FIG. 5F, which is an example user interface used by a services transaction system to revise a final bill submitted by a provider to reflect the last estimate made by the provider, in accordance with an embodiment of the present invention. In this example, provider 210 previously entered an amount of $125 as the billing amount and submitted the bill. In response, STS server 220 displays user interface 550 which (1) displays a message 552 that explains the error, (2) displays an indication 554 of where the error occurs in the form, and (3) displays a revised total 556 which is equal to the last estimated amount. It may be appreciated by one skilled in the art that the algorithm presented herein for ensuring consistency between estimate(s) and the final bill is just one of many algorithms that may be used. For example, it would be possible for customer 210 and provider 230 to agree that the final bill would not exceed the last estimate by 25%.

Now reference is made to FIG. 5G, which is an example user interface used by a provider to provide feedback following a transaction, in accordance with an embodiment of the present invention. Example user interface 560 provides a session feedback (also referred to as an evaluation) form 562 that enables a provider 230 to: (1) specify whether he/she would be willing to provide a service to customer 210 again by selecting among three choices (Yes, No, Undecided); (2) provide tags, also referred to as keywords, that can be used for searching; and (3) enter comments. It may be appreciated by one skilled in the art that a determination of whether a provider would be willing to provide a service to a customer again may be considered a “customer rating” when the data is aggregated across many service providers. Evaluation data is summarized by STS server 220 and may be made available to other providers along with comments to help a provider determine inter alia whether or not to agree to provide service to a particular customer, or whether to require pre-authorization of payment.

Now reference is made to FIG. 5H, which is an example user interface used by a customer to provide feedback following a transaction, in accordance with an embodiment of the present invention. Example user interface 570 provides a session feedback (also referred to as an evaluation) form 572 that enables a customer 210 to: (1) specify whether provider 230 was able to resolve their problem; (2) leave comments; and (3) specify whether he/she would select provider 230 again. It may be appreciated by one skilled in the art that both a determination of whether a provider was able to solve a customer's problem and a determination of whether a customer would select a given provider again may be considered as “service provider ratings” and the data may be aggregated across many customers. Evaluation data is summarized by STS server 220 and may be made available to other customers along with comments to help a customer determine inter alia whether or not to select a particular provider to provide a service, and to determine the order in which to display providers in a list of search results.

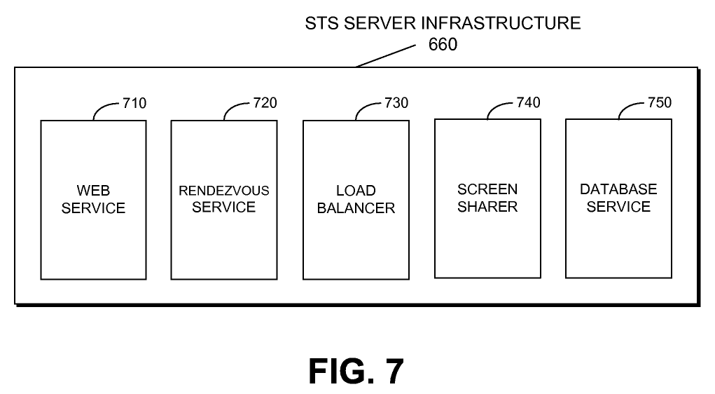

Now reference is made to FIG. 6, which is an example software architecture for a services transaction system server computer, in accord with an embodiment of the present invention. The software architecture illustrated in FIG. 6 shows the software components that provide the custom, i.e. application specific, logic performed by STS server 220. STS server 220 includes a customer interface 605, a chat service 610, a provider interface 615, an administrative interface 620, a payment manager 625 and a data storage 630. Data storage 630 includes a number of logical databases, namely customer account database 635, customer history database 640, provider account database 645, provider history database 650, and transaction history database 655. STS server 220 further includes an STS Server Infrastructure 660 component which includes a collection of relatively standard sub components available from third parties for integration into an Internet server. STS server infrastructure 660 is further described with reference to FIG. 7.

Customer interface 605 handles interaction between customer 210 and STS server 220 and provider 230. It enables customer 210 to receive and send chat messages and to interact using structured forms. Additionally, in one embodiment, customer interface 605 enables a customer 210 user interface to be shared and remotely controlled by provider 230 using a screen sharer (described with reference to FIG. 7).

Chat service 610 enables customer 210, provider 230, and administrator 240 to interactively chat. Further, STS server 220 may issue messages to customer 210, provider 230 and administrator 240 using chat service 610. In one embodiment, chat service 610 is based on the widely adopted open protocol for instant messaging, XMPP (also named Jabber). XMPP was formalized by the IETF in 2002-2004 and is maintained by the XMPP Standards Foundation which can be found at http://xmpp.org/. Numerous developer tools are available for implementing XMPP in an Internet server.

Customer interface 605 also relies on a rendezvous service, provided by STS server infrastructure 660, to establish client-server communications between customer 210 and provider 230. In one embodiment, STS 200 does not support unattended sessions and requires the presence of a person to accept a session request from the person on the other side. For example, if customer 210 identifies a potential provider and wants to initiate a chat session, it is necessary for the provider to be present in order to initiate the session. Customer interface 605 generates a session ID for each session between customer 210 and provider 230. The session ID is used as a key to encrypt communications. Files and messages exchanged across STS 200 are encrypted to ensure user privacy. In one embodiment, data is encrypted at the endpoints using a 128-bit encryption method provided by Blowfish. Blowfish is a symmetric block cipher encryption algorithm. Further information about Blowfish can be found at http://www.schneier.com/blowfish.html.

In one embodiment the session ID is used as a key to store all session information in transaction history database 655. In one embodiment, if customer 210 and provider 230 do not conclude a transaction during a single session, when they resume communications the new session is linked using the session ID; thus a transaction which comprises multiple sessions can be reconstituted from transaction history database 655.

Provider interface 615 handles interaction between provider 230, STS server 220 and customer 210. It enables provider 230 to receive and send chat messages and to interact using structured forms. Additionally provider interface 615 enables provider 230 to access the personal computer of customer 210 via screen sharer 610, typically for purposes of performing a technical support service.

Payment manager 625 uses the payment method information provided by customer 210 to authorize and settle electronic payments. In one embodiment, payment manager 625 causes the payment to be deposited directly into a customer payments bank account managed by STS 200. Payment manager 625 can access a plurality electronic payment systems, including PayPal, a service owned and operated by eBay, Inc. of Mountain View, Calif., and standard credit card networks including VISA, MasterCard and American Express. On a periodic basis, e.g. weekly, biweekly or monthly, payment manager 625 disburses payments aggregated in the customer payment account by allocating a percentage of each payment for a service received during the last period to commissions payable to STS 200, and a percentage to the provider of the service. Payment manager causes amounts aggregated and allocated to provider 230 to be paid to provider 230 typically by direct deposit to a bank account designated by provider 230.

Customer account database 635 stores the name, contact information, date registered and method of payment information for each registered customer 210 in a customer account record. A customer history database 640 stores historical information for each customer in a customer history record. The customer history record includes the customer name and summary information for each session that he/she has transacted. Session information includes the service requested, the date, the name of the service provider, evaluation by the customer of the provider, and payment details.

Provider account database 645 stores the name, contact information, date registered and payment information for each registered provider 230 in a provider account record. A provider history database 640 stores historical information for each provider in a provider history record. The provider history record includes the provider name and summary information for each session that he/she has transacted. Session information includes the service requested, the date, the name of the customer, evaluation by the provider of the customer, and payment details.

Transaction history database 655 stores a record of each session and each transaction. Such record includes a session id for each session in the transaction, each message exchanged between customer 210 and provider 230 and data for each form exchanged between customer 210 and provider 230. Transaction history database 655 also stores a record of each payment and disbursement made by payment manager 625.

Now reference is made to FIG. 7, which is a block diagram of an example server infrastructure that identifies software components included in a services transaction system server computer, in accord with an embodiment of the present invention. Many of the infrastructure components identified in FIG. 7 are provided by third party software modules that are licensed for use with STS server 220. STS server infrastructure 660 includes a web service 710, a rendezvous service 720, a load balancer 730, a screen sharer 740, and a database service 750.

Web service 710 provides a standard Web server capability such as that provided by the Apache Web Server. Further information about the Apache Web Server can be found at http://www.apache.org/. In addition, Web service 710 may include a mechanism for extending the functionality of a Web server such as that provided by a Java Enterprise Edition application server such as JBoss. JBoss is provided by Red Hat, Inc. of Raleigh, N.C. Further information about JBoss can be found at http://www.redhat.com/.

Rendezvous service 720 allows a client computer to exchange messages with other peers on the network. It enables a client computer used by customer 210 to exchange messages such as interactive chat messages or screen sharing data, with a client computer used by provider 230. In one embodiment, the rendezvous service is based on the JXTA open source peer-to-peer protocol. Further information about JXTA can be found at https://jxta.dev.java.net/.

Load balancer 730 enables a group of physical computer servers to implement STS server 220 by running the various software applications and services as if they were running on a single server. In one embodiment, load balancer 730 is implemented using JBoss from Red Hat.

Screen sharer 740 enables customer 210 user interface to be shared and remotely operated by provider 230. For example, screen sharer 740 enables provider 230 to look at data on the client computer used by customer 210 and to remotely execute and view the results of programs on the client computer used by customer 210. In one embodiment, screen sharer 740 functions are performed by a TightVNC software plug-in, an open source remote control software package maintained by Constantin Kaplinsky. Additional information about one embodiment of screen sharer 740 is available at http://www.crossloop.com/ipage.htm?id=howitworks.

Database service 750 enables STS server 220 to implement and access standard SQL relational databases through an ODBC or JDBC interface. In one embodiment, customer account database 635, customer history database 640, provider account database 645, provider history database 650 and transaction history database 655 are implemented as SQL databases and are accessed using database service 760. Access to the underlying database management system (DBMS) is provided using the ODBC or JDBC interface. Further the underlying DBMS is typically provided using a standard DBMS such as Oracle from Oracle Corporation of Redwood Shores, Calif.

In reading the above description, persons skilled in the art will realize that there are many apparent variations that can be applied to the methods and systems described.

What is claimed is:

1. A method of entering into and performing a service agreement, comprising:
(a) maintaining a provider account database comprising records for service providers, each record including (i) a name for a service provider, and (ii) a description of the services provided by the service provider;
(b) providing a website that enables a customer to interactively select a service provider from the provider account database;
(c) enabling said service provider to provide an electronic estimate form that includes a description of work to be performed and an estimated price;
(d) enabling said customer to accept or reject said price estimate;
(e) enabling said service provider to submit a bill for work performed following acceptance of said price estimate;
(f) enabling said customer and said service provider to exchange messages via interactive chat wherein said chat is in reference to exchanged forms and bill data; and
(g) electronically obtaining money from the customer and transferring the money to an account from which the service provider is paid.

2. The method of claim 1 further comprising storing a record of all forms data, bills, and interactive chat messages exchanged between said customer and said service provider.

3. The method of claim 1 further comprising enabling said service provider to require that customer payment in the amount of said estimate be pre-authorized prior to said service provider performing the work.

4. The method of claim 1 further comprising electronically pre-authorizing payment of the amount of said estimate by said customer.

5. The method of claim 1 further comprising enabling said service provider to revise said estimate if the estimate is rejected by said customer.

6. The method of claim 5 further comprising enabling said service provider to revise said estimate if the estimate changes during performance of said work.

7. The method of claim 6 further comprising rejecting an electronic bill from said service provider if the price of said electronic bill is greater than the price included in the last estimate accepted by said customer.

8. The method of claim 1 wherein said electronically obtaining payment is performed after a predetermined holding period during which time said customer may dispute said electronic bill.

9. The method of claim 1 further comprising enabling said service provider to provide feedback about said customer wherein said feedback includes at least one of a customer rating, text comments, or tags that can be used for searching.

10. The method of claim 1 further comprising enabling said customer to provide feedback about said service provider wherein said feedback includes at least one of a service provider rating, or text comments.

11. The method of claim 9 further comprising providing to said service provider the ability to view feedback about said customer provided by other service providers.

12. The method of claim 10 further comprising providing to said customer the ability to view feedback about said service provider provided by other customers.

13. A system for entering into and performing a service agreement, comprising:
(a) a provider account database comprising records for service providers, each record including (i) a name for a service provider, and (ii) a description of the services provided by the service provider;
(b) a website that enables a customer to interactively select a service provider from the provider account database;
(c) a provider interface for:
enabling said service provider to provide an electronic estimate form that includes a description of work to be performed and an estimated price;
enabling said service provider to submit a bill for work performed following acceptance of said price estimate;
(d) a customer interface for enabling said customer to accept or reject said price estimate;
(f) a chat service for enabling said customer and said service provider to exchange messages via interactive chat wherein said chat is in reference to exchanged forms and bill data; and
(g) a payment manager for electronically obtaining money from the customer and transferring the money to an account from which the service provider is paid.

14. The system of claim 13 further comprising a data storage for storing a record of all forms data, bills, and interactive chat messages exchanged between said customer and said service provider.

15. The system of claim 13 further comprising enabling by said provider interface said service provider to require that customer payment in the amount of said estimate be pre-authorized prior to said service provider performing the work.

16. The system of claim 13 further comprising electronically pre-authorizing payment by said payment manager of the amount of said estimate by said customer.

17. The system of claim 13 further comprising enabling by said provider interface said service provider to revise said estimate if the estimate is rejected by said customer.

18. The system of claim 17 further comprising enabling by said provider interface said service provider to revise said estimate if the estimate changes during performance of said work.

19. The system of claim 18 further comprising rejecting by said provider interface an electronic bill from said service provider if the price of said electronic bill is greater than the price included in the last estimate accepted by said customer.

20. The system of claim 13 wherein said electronically obtaining payment is performed after a predetermined holding period during which time said customer may dispute said electronic bill.

21. The system of claim 13 further comprising enabling by said provider interface said service provider to provide feedback about said customer wherein said feedback includes at least one of a customer rating, text comments, or tags that can be used for searching.

22. The system of claim 13 further comprising enabling by said customer interface said customer to provide feedback about said service provider wherein said feedback includes at least one of a service provider rating, or text comments.

23. The system of claim 21 further comprising providing by said provider interface to said service provider the ability to view feedback about said customer provided by other service providers.

24. The method of claim 22 further comprising providing by said customer interface to said customer the ability to view feedback about said service provider provided by other customers.

25. A computer readable storage medium storing program code for causing a computing device:
(a) to maintain a provider account database comprising records for service providers, each record including (i) a name for a service provider, and (ii) a description of the services provided by the service provider;
(b) to provide a website that enables a customer to interactively select a service provider from the provider account database;
(c) to enable said service provider to provide an electronic estimate form that includes a description of work to be perform and an estimated price;
(d) to enable said customer to accept or reject said price estimate;
(e) to enable said service provider to submit a bill for work performed following acceptance of said price estimate;
(f) to enable said customer and said service provider to exchange messages via interactive chat wherein said chat is in reference to exchanged forms and bill data; and
(g) to electronically obtain money from the customer and transfer the money to an account from which the service provider is paid.
